(19) United States
(12) Patent Application Publication
(10) Pub. No.: US 2005/0172280 A1
(43) Pub. Date: Aug. 4, 2005

(54) System and method for preintegration of updates to an operating system

(76) Inventors: Jeremy R. Ziegler, Pflugerville, TX (US); Bruce A. Zabava, Pflugerville, TX (US)

Correspondence Address: HAMILTON & TERRILE, LLP, P.O. BOX 203518, AUSTIN, TX, 78720, US

(21) Appl. No.: 10/766,984

(22) Filed: Jan. 29, 2004

(51) Int. Cl. G06F 9/44

(52) U.S. Cl. 717/168; 717/174

(57) ABSTRACT

An operating system has security updates preintegrated to reduce vulnerability of the operating system to malicious programs, such as worms. Preintegration writes update files over corresponding operating system files before boot of the operating system so that malicious programs are not provided an opportunity to attack the operating system during a post-boot security update. An update package extracts update files, such as QFE files, and prepares the update files within a file and directory structure corresponding to the operating system. An overwrite engine running on an alternative operating system writes the update files to the operating system so that the operating system boots secure from attack by worms that the updates are intended to prevent.

### BACKGROUND OF THE INVENTION

1. Field of the Invention

The present invention relates in general to the field of updates to an information handling system operating system, and more particularly to a system and method for preintegration of updates to a post-configured operating system image.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems generally rely on operating systems, such as the WINDOWS operating system sold by MICROSOFT, to coordinate operations of the various hardware and software components. To maintain operating systems as current as possible with respect to changes in hardware and software components, operating system manufacturers often issue updates, commonly known as patches, that correct problem areas until a new operating system version is released. For instance, MICROSOFT issues Quick Fix Engineering (QFE) releases that update WINDOWS when issues arise that require more immediate attention. One common reason for the issue of a QFE is to correct security vulnerabilities that are periodically uncovered. A variety of malicious programs, known as viruses, attack security vulnerabilities through the Internet to invade and sometimes even destroy information handling systems. One particularly disruptive type of virus is known as a worm. Once a worm infects an information handling system, it quickly spreads to other information handling systems and automatically multiplies by attacking a security vulnerability to sometimes create such heavy network traffic that networks attacked by the worm fail. Information handling systems that receive security updates via QFEs are protected from attack by worms that attack the updated vulnerability.

Although a QFE prevents worms from attacking a vulnerability updated by the QFE, information handling systems that fail to implement the QFE remain vulnerable. For example, information handling systems loading a new operating system remain vulnerable after initial boot of the operating system until a QFE engine installs the QFE. Typically, a new copy of WINDOWS includes a QFE package and install engine provided with an update CD or by download from an Internet site that update the operating system against known security vulnerabilities. However, in order to install the QFE, the native operating system generally must boot and become operational to run the install engine, thus leaving the operating system vulnerable to worms that the updates are intended to prevent until after the install engine runs. Information handling system manufacturers often create images of the operating system that are copied directly to hard disc drives of manufactured information handling systems. Copying an operating system image saves time by eliminating individual installations of the operating system on each manufactured information handling system, however, if the operating system image includes a worm or other virus, then each information handling system manufactured with the image will spread the worm or virus.

### SUMMARY OF THE INVENTION

Therefore a need has arisen for a system and method which protects an operating system from attack of a security vulnerability due to the operational state of the operating system as the security update is performed.

In accordance with the present invention, a system and method are provided which substantially reduce the disadvantages and problems associated with previous methods and systems for performing operating system security updates. Update files are written over corresponding operating system files so that the update takes effect on initial boot of the operating system without having to wait for the operating system to install the updates.

More specifically, an update package engine extracts update files from an update, such as a QFE, and places the update files in a file and directory structure to replace corresponding operating system files. An operating system preparation engine creates a base image with the primary source file removed and the update file and directory structure aligns the overwriting of corresponding secondary source files. An overwrite engine operating on an alternative operating system writes the update files over the corresponding operating system files and boots the operating system with the update files preintegrated. After boot, the update installer registers the update with the operating system and an operating system image creation engine prepares an image of the operating system for use in manufacture of information handling systems.

The present invention provides a number of important technical advantages. One example of an important technical advantage is that an operating system has its security updates performed before the operating system is vulnerable to attack by viruses and worms. In a manufacturing environment, an operating system image is created that has security updates installed before boot of the operating system that becomes the image. Preintegration of the security updates to a post-configured operating system image protects against unintentional propagation of known viruses and worms. The secure operating system image reduces the risk of disruption of the manufacturing environment by preventable viruses or worms.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an update preintegration engine for preintegration of updates to an operating system; and

FIG. 2 depicts a process for preintegration of updates into an operating system.

### DETAILED DESCRIPTION

An update to an information handling system operating system is preintegrated into the operating system to reduce vulnerability to malicious programs. Update files are written over corresponding operating system files so that the update takes effect on initial boot of the operating system without having to wait for the operating system to install the updates. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

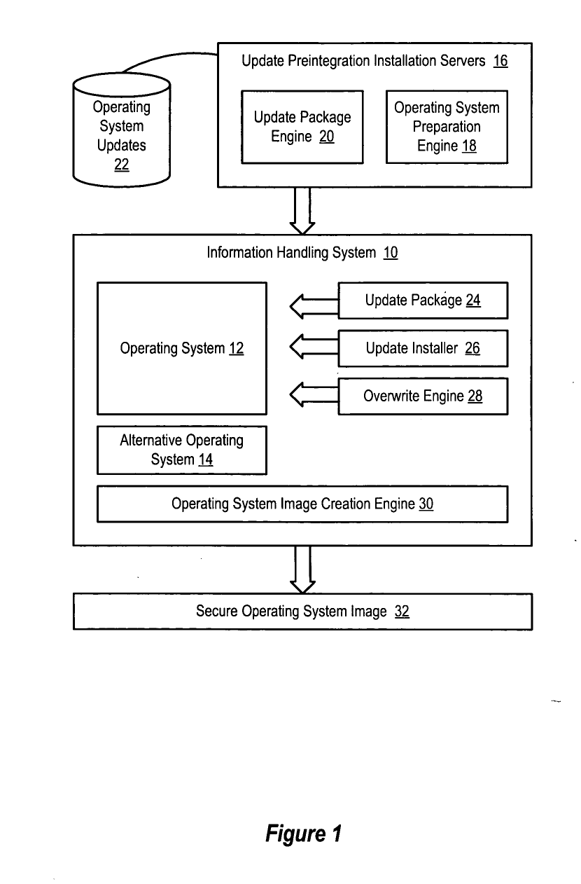

Referring now to FIG. 1, a block diagram depicts an information handling system 10 that prepares an operating system 12, such as WINDOWS, for use as an image for manufacture of similarly configured information handling systems. Operating system 12 initially is in a non-operative mode with information handling system 10 operating under alternative operating system 14, such as DOS, Linux or WinPE. For instance, alternative operating system 14 is downloaded to information handling system 10 through a PXE client and then downloads operating system 12 from an update preintegration installation server 16.

Update preintegration server 16 includes an operating system preparation engine 18 that prepares operating system 12 as a base image having its primary source file removed. For instance, with the WINDOWS operating system, operating system preparation engine 18 completely removes the DLLCACHE, which is the primary reference for the operating system to replace native files. In addition, operating system preparation engine 18 directs operating system 12 to a local directory for its second source for native files. The operating system base image as prepared by operating system preparation engine 18 is stored in local permanent memory of information handling system, such as a hard disc drive, as operating system 12.

Update preintegration server 16 also includes an update package engine 20 which retrieves operating system updates, such as QFEs, from an operating system updates database 22. Update package engine 20 extracts updated operating system files from the updates and packages the updated operating system files in an update package 24 that is downloaded to information handling system 10 to directly replace corresponding files in operating system 12 before booting of operating system 12. Update package 24 replaces the files in the directory of operating system 12 that operating system 12 utilizes directly, and also replaces the files in the second source, such as I386 files, if operating system 12 tries to replace the files in the directory with second source files. Update package engine 20 provides with update package 24 an overwrite engine 28 that runs on alternative operating system 14 to write the updated files over the corresponding operating system 12 files and second source files. Update package engine 20 includes the digital signature files associate with the update files to ensure that operating system 12 will recognize the update files as digitally signed. Update package engine 20 also includes the update installer 26 associated with the update files so that update installer 26 registers the update with the operating system.

Once information handling system 10 is operating with alternative operating system 14, overwrite engine 28 executes to write the updated files of update package 24 over the corresponding files of operating system 12. Upon completing the overwrite, operating system 12 boots in a normal sequence by loading onto the processing components of information handling system 10, loading drivers for the components of information handling system 10 and initiating update installer 26. Because overwrite engine 28 has already written the updated files to operating system 10, security vulnerabilities that were addressed by the updates are enforced even before update installer 26 is able to run to replace the primary and secondary source files, which in the case of WINDOWS are the I386 and DLLCACHE files. In one embodiment, update package engine 20 selects only updates associated with correction of security vulnerabilities, such as worms, for inclusion in update package 24 and allows update installer 26 to install non-security updates after boot of operating system 12. Once operating system 12 is booted, an operating system image creation engine 30 copies operating system 12 to create a secure operating system image 32 for use in manufacture of information handling systems. Secure operating system image 32 is protected from worm infection by enforcement of updates from the initial boot of operating system 12. In alternative embodiments, a secure operating system may be deployed for normal use as described above to reduce the risk of virus infection, such as when a user installs a new operating system on an existing information handling system

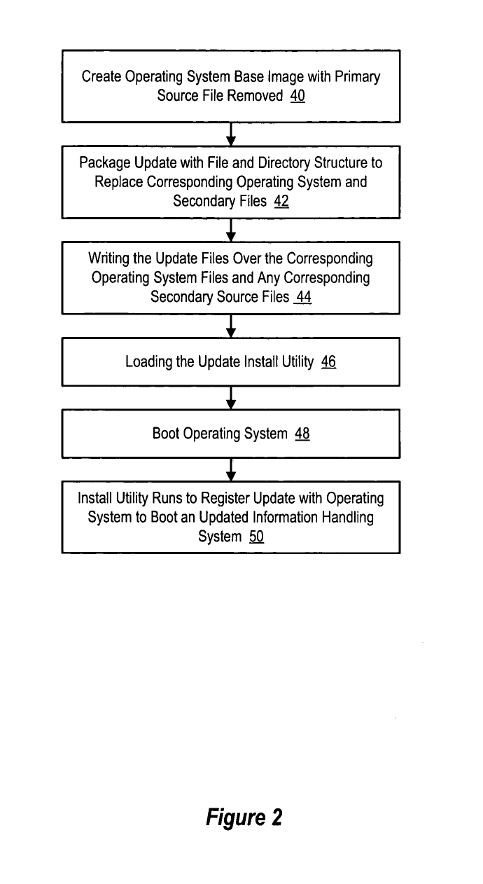

Referring now to FIG. 2, a process is depicted for the secure creation of an operating system with preintegrated updates. The process begins at step 40 with the creating of an operating system base image having the primary source file removed, such as the DLLCACHE of WINDOWS. At step 42, the update is packaged with a file and directory structure that replaces operating system files with corresponding updated files extracted from one or more operating system updates. The update also replaces secondary source files with the updated files to preclude the operating system from calling up secondary files vulnerable to attack. At step 44 the update files are written over the corresponding operating system and second source files under an alternative operating system before boot of the operating system that is receiving the update. At step 46, the update install utility, such as the QFE utility provided by MICROSOFT, is loaded on the information handling system to run after boot of the updated operating system so that the update is registered. At step 48, the updated operating system is booted secure from infection by worms or other malicious programs that the updates cover. At step 50, the process completes with execution of the install utility to register the update with the operating system. If additional updates remain for installation, the update install utility installs the additional updates in a conventional manner to have an updated operating system brought to a running state in a secure environment.

Although the present invention has been described in detail, it should be understood that various changes, substitutions and alterations can be made hereto without departing from the spirit and scope of the invention as defined by the appended claims.

1. A system for creating an operating system image, the image having preintegrated updates, the system comprising:
an operating system preparation engine operable to remove the operating system source file;
an update package engine operable to package one or more updates for integration with the operating system, each update having one or more files, the update package engine extracting the update files and assigning file and directory structures to the update files that replace corresponding files in the operating system directory;
an overwrite engine operable to write the packaged update files over the corresponding operating system files; and
an install engine operable to register the update with the operating system on initial boot of the operating system.

2. The system of claim 1 further comprising an alternative operating system operable to support the operation of the overwrite engine to write update files over the operating system files.

3. The system of claim 1 wherein the operating system has a primary and a secondary source files, the operating system preparation engine further operable to remove the primary source file, the update package engine further operable to identify an update source file and to assign the update source file to overwrite the corresponding secondary source file.

4. The system of claim 3 wherein the primary source file comprises the DLLCACHE and the secondary source file comprise I386.

5. The system of claim 1 wherein the update package engine is further operable to identify and select security updates for packaging.

6. The system of claim 5 wherein the security updates comprise updates operable to address a security vulnerability associated with worms.

7. The system of claim 1 wherein the updates comprise QFEs.

8. The system of claim 7 wherein the QFEs have digital signature files, the update package engine further operable to include the digital signature files with the update files.

9. The system of claim 1 further comprising an operating system image creation engine operable to copy the booted operating system as an image for use in manufacture of information handling systems.

10. A method for creating an operating system image, the image having integrated updates, the method comprising:
removing the source file of the operating system;
extracting an update file from an operating system update;
writing the update file over a corresponding operating system file;
booting the operating system; and
registering the update with the operating system.

11. The method of claim 10 wherein the operating system comprises a primary source file and a secondary source file and wherein:
removing the source file further comprises removing the primary source file; and
writing the update file further comprises writing a source file update over the secondary source file.

12. The method of claim 11 wherein the primary source file comprises DLLCACHE and the secondary source file comprises I386.

13. The method claim 10 wherein the update comprises a QFE.

14. The method of claim 10 wherein extracting an update file further comprises extracting a signature file to support recognition of the update file by the operating system.

15. The method of claim 10 further comprising running an alternate operating system to perform the removing, extracting and writing.

16. The method of claim 10 further comprising:
imaging the booted operating system; and
using the image to manufacture information handling systems.

17. The method of claim 10 further comprising:
identifying a plurality of updates as security updates and non-security updates;
selecting the security updates for the extracting and writing; and
installing the non-security updates after boot of the operating system.

18. The method of claim 17 wherein the security updates are patches to protect worm vulnerabilities.

19. An information handling system comprising:
an operating system having plural files, the operating system in a non-operational state;
an alternative operating system operable to support operation of the information handling system;
an update package supported by the alternative operating system, the update package having one or more update files for integration with the operating system, the update files having a file and directory structure aligned to replace corresponding files in the operating system;
an overwrite engine operable to write the update files over the corresponding operating system files to preintegrate the update files in the operating system.

20. The information handling system of claim 19 further comprising an operating system image creation engine operable to:
boot the operating system; and
copy an image of the booted operating system for use in manufacture of information handling systems.
